(19) United States
(12) Patent Application Publication
(10) Pub. No.: US 2020/0149668 A1
(43) Pub. Date: May 14, 2020

(54) Telescopic Leaf Blower Extension Apparatus

(71) Applicant: Michael Mason, Sacramento, CA (US)

(72) Inventor: Michael Mason, Sacramento, CA (US)

(21) Appl. No.: 16/190,348

(22) Filed: Nov. 14, 2018

(51) Int. Cl. F16L 27/12; F16L 33/06

(52) U.S. Cl. CPC F16L 27/12; A01G 20/47; F16L 33/06

(57) ABSTRACT

A telescopic leaf blower extension apparatus for extending a leaf blower hose includes a proximal tube that is configured to attach to a flex tube of a leaf blower. A distal tube is coupled to the proximal tube. The distal tube is telescopably coupled to the proximal tube. The distal tube has a retracted position within the proximal tube and an alternate extended position. A clamp means is coupled to the proximal tube and is selectively engageable with the distal tube to prevent the distal tube from moving between the retracted position and the alternate extended position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to leaf blower accessories and more particularly pertains to a new leaf blower accessory for extending a leaf blower hose.

### BRIEF SUMMARY OF THE INVENTION

An embodiment of the disclosure meets the needs presented above by generally comprising a proximal tube that is configured to attach to a flex tube of a leaf blower. A distal tube is coupled to the proximal tube. The distal tube is telescopably coupled to the proximal tube. The distal tube has a retracted position within the proximal tube and an alternate extended position. A clamp means is coupled to the proximal tube and is selectively engageable with the distal tube to prevent the distal tube from moving between the retracted position and the alternate extended position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a telescopic leaf blower extension apparatus according to an embodiment of the disclosure.

FIG. 2a is an isometric view of an embodiment of the disclosure.

FIG. 2b is an isometric view of an embodiment of the disclosure.

FIG. 3 is an exploded isometric view of an embodiment of the disclosure.

FIG. 4a is a cross-sectional view of an embodiment of the disclosure.

FIG. 4b is a cross-sectional view of an embodiment of the disclosure.

### DETAILED DESCRIPTION OF THE INVENTION

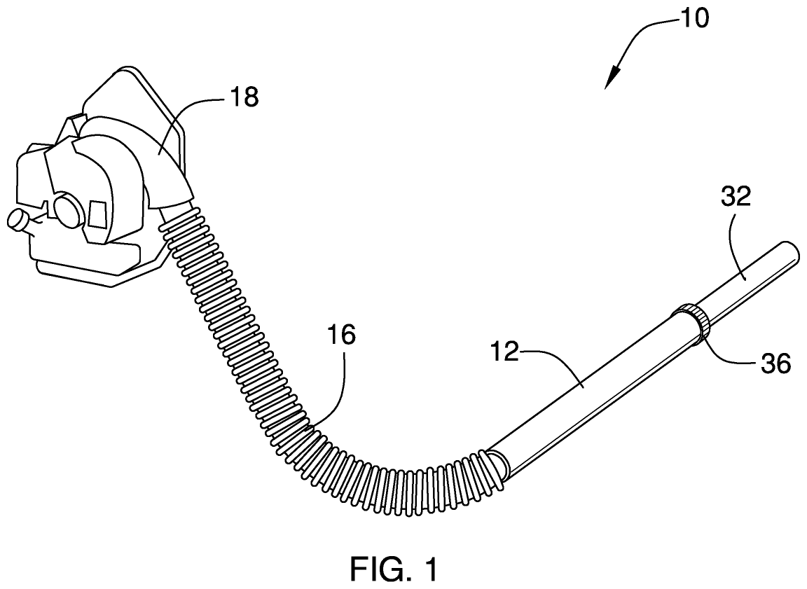

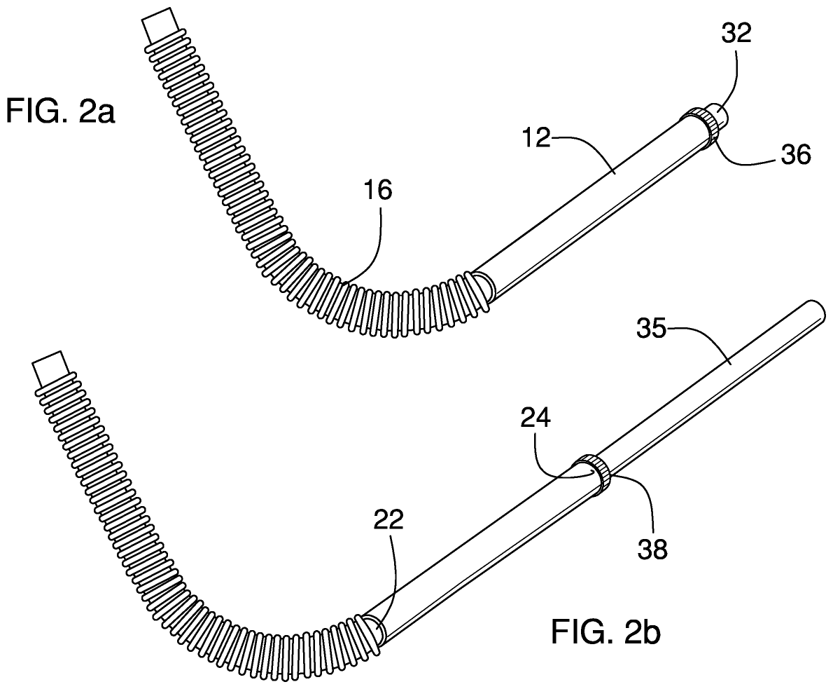

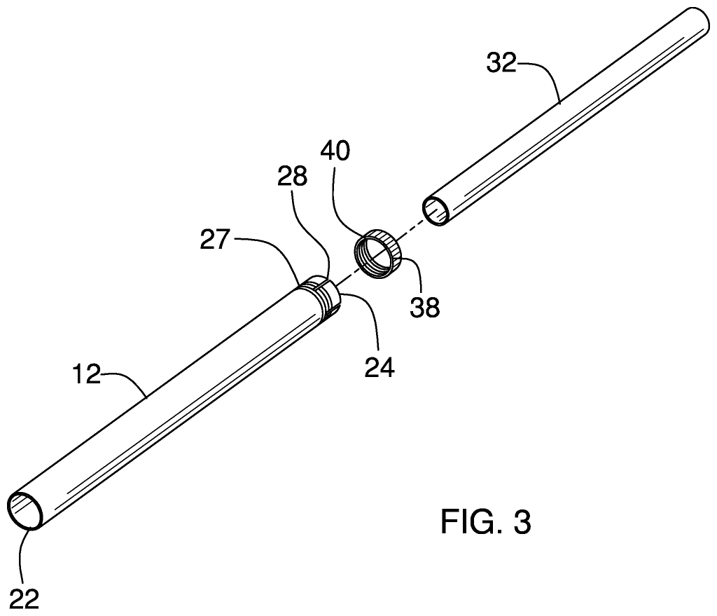

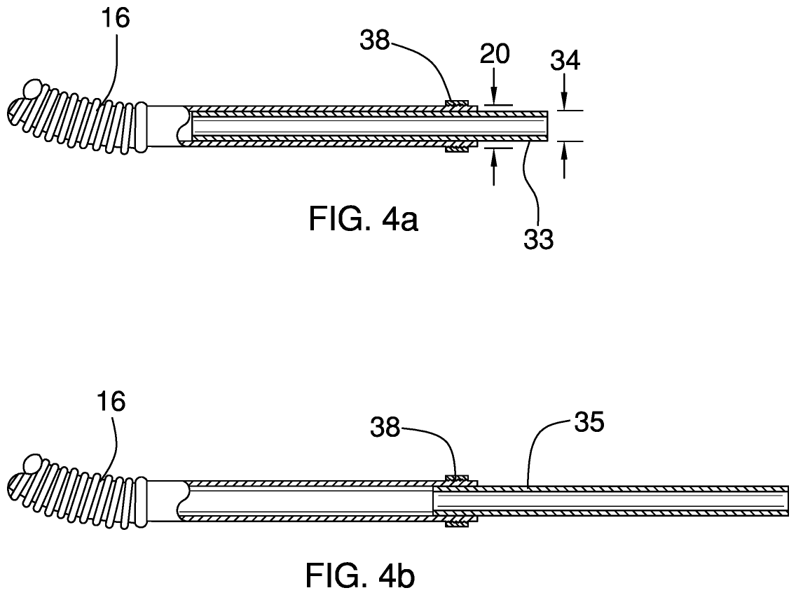

With reference now to the drawings, and in particular to FIGS. 1 through 4b thereof, a new leaf blower accessory embodying the principles and concepts of an embodiment of the disclosure and generally designated by the reference numeral 10 will be described.

As best illustrated in FIGS. 1 through 4b, the telescopic leaf blower extension apparatus 10 generally comprises a proximal tube 12 being configured to attach to a flex tube 16 of a leaf blower 18. The proximal tube 12 has a first diameter 20, a blower end 22 and a clamp end 24. The blower end 22 is selectively engageable with the flex tube 16 with a press fit. The clamp end 24 has an outer threading 27 and a plurality of slots 28. Each of the plurality of slots 28 extends from the clamp end 24 through the outer threading 28. A distal tube 32 is telescopably coupled within the proximal tube 12. The distal tube 32 has a retracted position 33 within the proximal tube 12 and an alternate extended position 35. The distal tube 32 has a second diameter 34 that is less than the first diameter 20 and is slidable within the proximal tube 12. A clamp means 36 is coupled to the proximal tube 12 and is selectively engageable with the distal tube 32 to prevent it from moving between the retracted position 33 and the alternate extended position 35. The clamp means 36 may be a stationary twist clamp 38. The stationary twist clamp 38 has an inner threading 40 that is selectively engageable with the outer threading 27 of the clamp end 24 of the proximal tube 12. The stationary twist clamp 38 has an outer face 42 that has a plurality of grooves 44 to improve grip for easier twisting. The plurality of slots 28 allows the clamp end 24 to compress when the stationary twist clamp 38 is engaged to seize the distal tube 32.

In use, the blower end 22 is engaged to the flex tube 16 of the leaf blower 18. The stationary twist clamp 38 is loosened and the distal tube 32 is retracted and alternatively extended between the retracted position 33 and the alternate extended position 35 as desired. The stationary twist clamp 38 is then tightened to lock the distal tube 32 in place.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A telescopic leaf blower extension apparatus comprising:
a proximal tube, the proximal tube being configured to attach to a flex tube of a leaf blower;
a distal tube coupled to the proximal tube, the distal tube being telescopably coupled to the proximal tube, the distal tube having a retracted position within the proximal tube and an alternate extended position; and
a clamp means coupled to the proximal tube, the clamp means being selectively engageable with the distal tube to prevent the distal tube from moving between the retracted position and the alternate extended position.

2. The telescopic leaf blower extension apparatus of claim 1 further comprising the proximal tube having a first diameter and the distal tube having a second diameter, the second diameter being less than the first diameter, the distal tube being slidable within the proximal tube.

3. The telescopic leaf blower extension apparatus of claim 1 further comprising the proximal tube having a blower end and a clamp end, the blower end being selectively engageable with the flex tube with a press fit, the clamp end having an outer threading.

4. The telescopic leaf blower extension apparatus of claim 3 further comprising the clamp means being a stationary twist clamp, the stationary twist clamp having an inner threading, the inner threading being selectively engageable with the outer threading of the clamp end of the proximal tube.

5. The telescopic leaf blower extension apparatus of claim 4 further comprising the clamp end of the proximal tube having a plurality of slots, each of the plurality of slots extending from the clamp end through the outer threading, the plurality of slots allowing the clamp end to compress when the stationary twist clamp is engaged to seize the distal tube within the proximal tube.

6. The telescopic leaf blower extension apparatus of claim 4 further comprising the stationary twist clamp having an outer face, the outer face having a plurality of grooves.

7. A telescopic leaf blower extension apparatus comprising:
a proximal tube, the proximal tube being configured to attach to a flex tube of a leaf blower, the proximal tube having a first diameter, the proximal tube having a blower end and a clamp end, the blower end being selectively engageable with the flex tube with a press fit, the clamp end having an outer threading, the clamp end having a plurality of slots, each of the plurality of slots extending from the clamp end through the outer threading;
a distal tube coupled to the proximal tube, the distal tube being telescopably coupled to the proximal tube, the distal tube having a retracted position within the proximal tube and an alternate extended position, the distal tube having a second diameter, the second diameter being less than the first diameter, the distal tube being slidable within the proximal tube; and
a clamp means coupled to the proximal tube, the clamp means being selectively engageable with the distal tube by compressing the clamp end of the proximal tube between the plurality of slots to seize the distal tube within the proximal tube and prevent the distal tube from moving between the retracted position and the alternate extended position, the clamp means being a stationary twist clamp, the stationary twist clamp having an inner threading, the inner threading being selectively engageable with the outer threading of the clamp end of the proximal tube, the stationary twist clamp having an outer face, the outer face having a plurality of grooves.

8. A leaf blower and telescopic leaf blower extension apparatus system comprising:
a leaf blower, the leaf blower having a flex tube;
a proximal tube, the first tubular segment being configured to attach to a flex tube of a leaf blower, the proximal tube having a first diameter, the proximal tube having a blower end and a clamp end, the blower end being selectively engageable with the flex tube with a press fit, the clamp end having an outer threading, the clamp end having a plurality of slots, each of the plurality of slots extending from the clamp end through the outer threading;
a distal tube coupled to the proximal tube, the distal tube being telescopably coupled to the proximal tube, the distal tube having a retracted position within the proximal tube and an alternate extended position, the distal tube having a second diameter, the second diameter being less than the first diameter, the distal tube being slidable within the proximal tube; and
a clamp means coupled to the proximal tube, the clamp means being selectively engageable with the distal tube by compressing the clamp end of the proximal tube between the plurality of slots to seize the distal tube within the proximal tube and prevent the distal tube from moving between the retracted position and the alternate extended position, the clamp means being a stationary twist clamp, the stationary twist clamp having an inner threading, the inner threading being selectively engageable with the outer threading of the clamp end of the proximal tube, the stationary twist clamp having an outer face, the outer face having a plurality of grooves.
